(19) United States
(12) Patent Application Publication
(10) Pub. No.: US 2002/0107742 A1
(43) Pub. Date: Aug. 8, 2002

(54) System for and method of transacting non-fuel purchases using an island transaction terminal

(76) Inventor: J. Breck Magill, Elkhorn, WI (US)

Correspondence Address: J. Breck Magill, 909 Hazelridge, Elkhorn, WI, 53121, US

(21) Appl. No.: 09/776,261

(22) Filed: Feb. 2, 2001

(51) Int. Cl. G06F 17/60

(52) U.S. Cl. 705/17; 705/26; 700/231; 700/232

(57) ABSTRACT

The disclosure describes an exemplary system and method of transacting non-fuel purchases using an island transaction terminal. The method can include receiving customer identification information associated with a customer, obtaining authorization to offer a sale to the customer, offering a non-fuel purchase to the customer, and, upon receiving a request to make a non-fuel purchase, completing the sale of the requested non-fuel purchase.

### FIELD OF THE INVENTION

The present specification relates generally to point of sale systems and methods. More particularly, the present specification relates to a system for and a method of transacting non-fuel purchases using an island transaction terminal.

### BACKGROUND OF THE INVENTION

Recently, gasoline stations have been equipped with island terminals located near or as an integral part of gasoline pumping units which allow customers to pay for gasoline without having to walk into a store and pay an attendant. These convenient island terminals are sometimes referred to as “pay-at-the-pump” technology. In general, pay-at-the-pump technology allows customers to swipe a credit card through a credit card reader, receive authorization indicating that a purchase may be made, pump gasoline into a vehicle, and purchase the gasoline by credit.

While use of pay-at-the-pump technology is convenient for customers and can be safer for drivers (and passengers) by avoiding the need to leave a vehicle and enter a store, there are disadvantages to pay-at-the-pump technology. For example, gasoline stations can lose revenue from customers not entering the store and purchasing snacks, candy, drinks, maps, and other items which may be available. As such, gasoline stations experience lost revenue from lack of buying at the point of sale in the store. Revenue from impulse purchases is also lost with pay-at-the-pump technology because non-fuel items are not available to the customer where they are paying for gasoline. Customers using pay-at-the-pump technology may not want wait in line for food, drinks, and other purchases because often they use pay-at-the-pump technology to avoid waiting in line to make a purchase. Another reason why customers may use pay-at-the-pump technology is to avoid going into a store during inclement weather or leaving children unattended in a vehicle.

As such, despite the attractions of pay-at-the-pump technology, there are lost opportunities to make sales. Gasoline stations often invest a great deal of money in store space and human resources in order to make non-fuel sales. Some gasoline stations include convenience stores of significant sizes to increase sales of non-fuel items. Non-fuel items often have a superior profit margin compared to fuel sales.

Thus, there is a need for making sales of non-fuel items to customers using pay-at-the-pump technology. Further, there is a need to recoup investment made in non-fuel items by making them available for purchase at the pump. Yet further, there is a need for a system for and method of transacting non-fuel purchases using an island transaction terminal.

The teachings hereinbelow extend to those embodiments which fall within the scope of the appended claims, regardless of whether they accomplish one or more of the above-mentioned needs.

### SUMMARY OF THE INVENTION

An exemplary embodiment relates to a method of transacting non-fuel purchases using an island transaction terminal. This method can include receiving customer identification information associated with a customer, obtaining authorization to offer a sale to the customer, offering a non-fuel purchase to the customer, and, upon receiving a request to make a non-fuel purchase, completing the sale of the requested non-fuel purchase.

Another exemplary embodiment relates to a system for transacting non-fuel purchases using an island transaction terminal. This system can include a gasoline pump terminal and a vending machine terminal. The gasoline pump terminal includes a customer information input device, a display screen, and a selection device. The vending machine terminal is coupled to the gasoline pump terminal and is configured to dispense non-fuel items upon purchase by a customer.

Another exemplary embodiment relates to a system for transacting non-fuel purchases using an island transaction terminal. This system can include means for receiving customer identification information associated with a customer, means for obtaining authorization to offer a sale to the customer, means for offering a non-fuel purchase to the customer, and means for completing the sale of the requested non-fuel purchase upon receiving a request to make a non-fuel purchase.

Another exemplary embodiment relates to a method executed by a computing device to transact non-fuel purchases using an island transaction terminal. This method includes presenting a display at a gasoline pump terminal, presenting non-fuel purchase options at the display, and, upon receiving a selection of a non-fuel purchase, transacting the purchase of the non-fuel selection.

Another exemplary embodiment relates to an island transaction terminal including a gasoline pump portion and a vending machine portion. The gasoline pump portion is configured to dispense gasoline and communicate gasoline purchase information. The vending machine portion is configured to present non-fuel items for selection and purchase. The vending machine portion is coupled to the gasoline pump portion.

Other features and advantages of embodiments of the present invention will become apparent to those skilled in the art upon review of the following drawings, the detailed description, and the appended claims.

### BRIEF DESCRIPTION OF THE DRAWINGS

The present specification is illustrated by way of example and not limitation in the figures of the accompanying drawings, in which like references indicate similar elements and in which:

FIG. 1 is a general perspective view schematic representation of a gasoline service station incorporating an exemplary embodiment;

FIG. 2 is a general schematic block diagram of a system for transacting non-fuel purchases using an island transaction terminal in accordance with another exemplary embodiment;

FIG. 3 is a more detailed perspective view schematic representation of a gasoline service station pump including a vending machine terminal in accordance with still another exemplary embodiment;

FIG. 4 is a more detailed perspective view schematic representation of a gasoline service station pump coupled to a vending machine terminal in accordance with yet another exemplary embodiment;

FIG. 5 is a more detailed schematic representation of a display on a gasoline service station pump in accordance with an exemplary embodiment; and

FIG. 6 is a flow diagram illustrating a process for transacting non-fuel purchases using an island transaction terminal in accordance with an exemplary embodiment.

### DETAILED DESCRIPTION OF THE EXEMPLARY EMBODIMENTS

A system for and method of transacting non-fuel purchases using an island transaction terminal is described herein. In the following description, for purposes of explanation, numerous specific details are set forth to provide a thorough understanding of exemplary embodiments of the invention. It will be evident, however, to one skilled in the art that the invention may be practiced without these specific details. In other instances, well-known structures and devices are shown in block diagram form to facilitate description of the exemplary embodiments.

In an exemplary embodiment, a computer system is used which has a processing unit that executes sequences of instructions contained in a memory. More specifically, execution of the sequences of instructions causes the processing unit to perform steps, which are described below. The instructions may be loaded into a random access memory (RAM) for execution by the processing unit from a read-only memory (ROM), a mass storage device, or some other persistent storage. In other embodiments, hardwired circuitry may be used in place of, or in combination with, software instructions to implement the exemplary embodiments. Thus, the embodiments described herein are not limited to any specific combination of hardware circuitry and software, nor to any particular source for the instructions executed by the computer system.

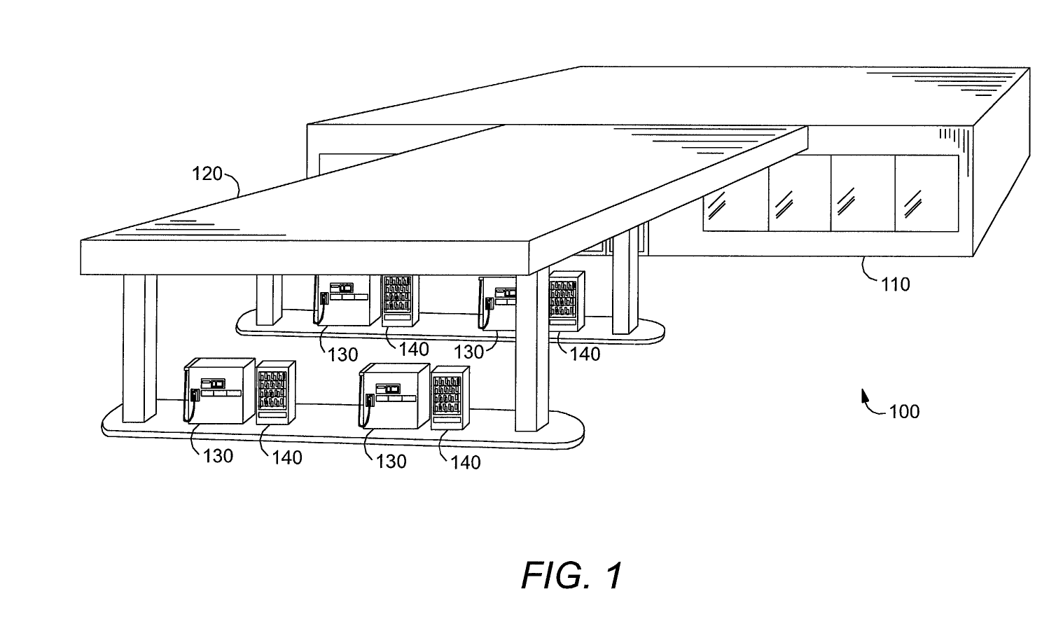

FIG. 1 illustrates a general schematic representation of a gasoline service station 100. In an exemplary embodiment, gasoline service station 100 includes a building 110, an extended awning 120, gasoline pump terminals 130, and vending machine terminals 140. Building 110 can generally include any facility housing a cashier or employee receiving payment for gasoline and other non-fuel items. In an exemplary embodiment, building 110 houses a convenience store, including snacks, beverages, maps, candy, and any of a variety of other non-fuel items.

In one embodiment, gasoline service station 100 includes extended awning 120 which is a roof-like structure which provides shelter from rain, snow, or direct sunlight. Extended awning 120 is preferably located over gasoline pump terminals 130. Gasoline pump terminals 130 are configured to dispense gasoline to vehicles. Dispensed gasoline can include a range of customer-selected octance grades (e.g., 87, 89, and 91). Vending machine terminals 140 are located proximate to gasoline pump terminals 130 and provide for the purchase of non-fuel items without having to enter building 110.

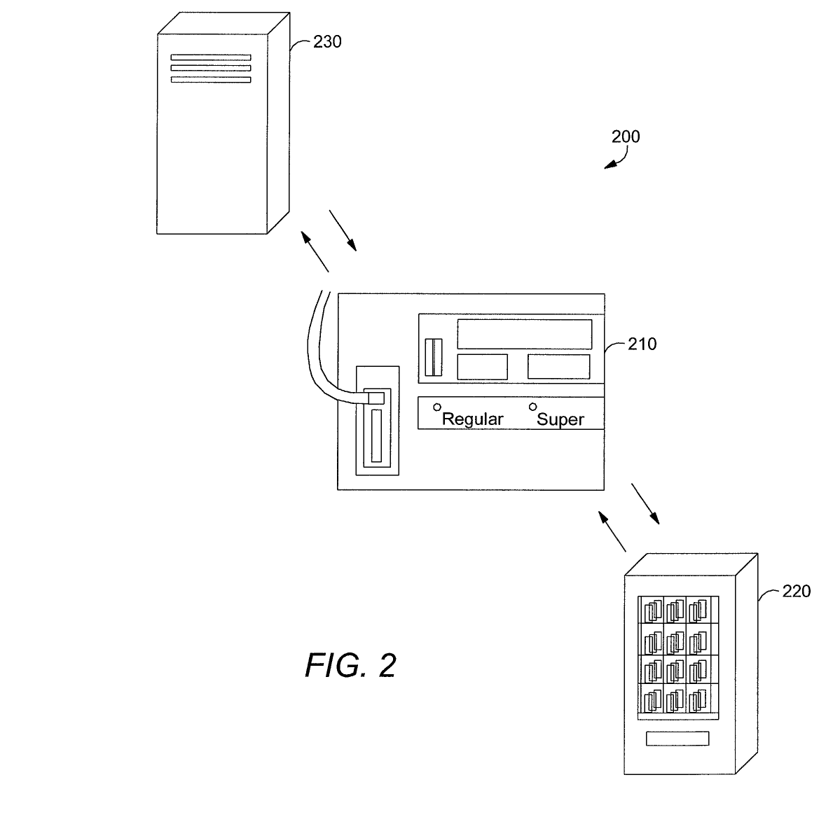

FIG. 2 illustrates a general block diagram 200 of a system for transacting non-fuel purchases using an island transaction terminal. In an exemplary embodiment, a customer swipes a credit card or provides some other identification apparatus or object, such as, the SPEEDPASS identification wand available from Mobile, Inc. to gasoline pump terminal 210. The customer can also insert a credit card, debit card, or pre-paid card into a slot in the gasoline pump terminal. Gasoline pump terminal 210 communicates customer information to a computer server 230 located remote from gasoline pump terminal 210. In an exemplary embodiment, communication to computer server 230 is provided over a private network. Alternatively, communication to computer server 230 can be provided over a public network, such as, the Internet using encryption techniques or other security features.

Computer server 230 can be used to provide reports and data to a central office or headquarters as well as receive updates and support from the central office. Information communicated to computer server includes information related to the point of sale transaction, such as, credit card data, inventory data, and vending machine status information. Computer server 230 can provide gasoline pump terminal 210 with a verification to allow vending machine terminal 220 to dispense a purchased non-fuel item. Alternatively, computer server 230 can communicate directly with vending machine terminal 220. Inventory data and report information can also be communicated to computer server 230 from vending machine terminal 220.

Once customer information is provided, authorization is determined and communicated to gasoline pump terminal 210. Once gasoline pump terminal 210 obtains positive authorization, the customer is able to pump gasoline. In addition, the customer can purchase non-fuel items from a vending machine terminal 220 which is communicatively coupled to gasoline pump terminal 210. In an exemplary embodiment, vending machine terminal 220 and gasoline pump terminal 210 are integrated into one unit. Alternatively, vending machine terminal 220 and gasoline pump terminal 210 are separate units, but are coupled to each other by some communication means, such as, a cable, radio frequency (RF) transmitter and receiver, a BLUETOOTH technology device, or any other mechanism which allows vending machine terminal 220 to communicate with gasoline pump terminal 210. In yet another embodiment, vending machine terminal 220 is coupled to multiple gasoline pump terminals.

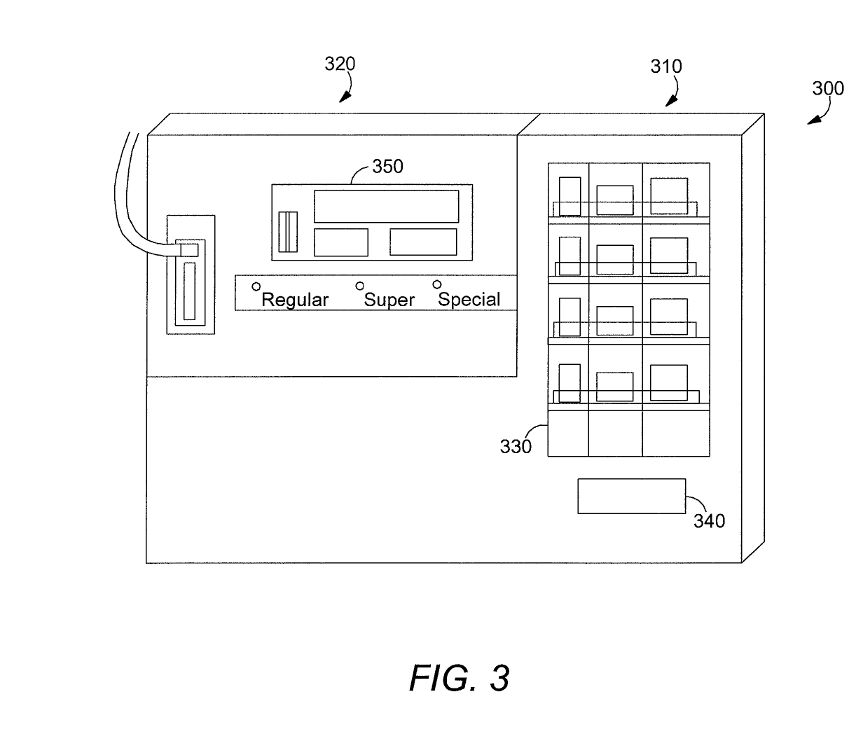

FIG. 3 illustrates a gasoline pump 300 including a vending machine portion 310 and a gasoline pump portion 320. Vending machine portion 310 includes a presentation window 330 and a retrieval opening 340. Presentation window 340 includes a glass or Plexiglas covering which allows customers to view items contained in vending machine portion 310. Gasoline pump portion 320 includes a display panel 350. In an exemplary embodiment, display panel 350 includes a screen, a numeric keypad, a credit card swiping device, and a receipt printer. Alternatively, display panel 350 can integrate a screen and numeric keypad into one device, such as, a touch screen.

In an exemplary embodiment, the customer selects items by pressing a button near the item the customer wants from vending machine portion 310. Alternatively, vending machine portion 310 can be configured to allow the customer to enter a number in display panel 350. In yet another embodiment, a separate keypad corresponding to numbers identifying non-fuel items is provided for vending machine portion 310. Advantageously, the customer can purchase fuel and non-fuel items in one transaction without having to leave the vehicle and enter a store. Non-fuel selections from vending machine portion 310 are automatically added to the gasoline purchase made by the customer.

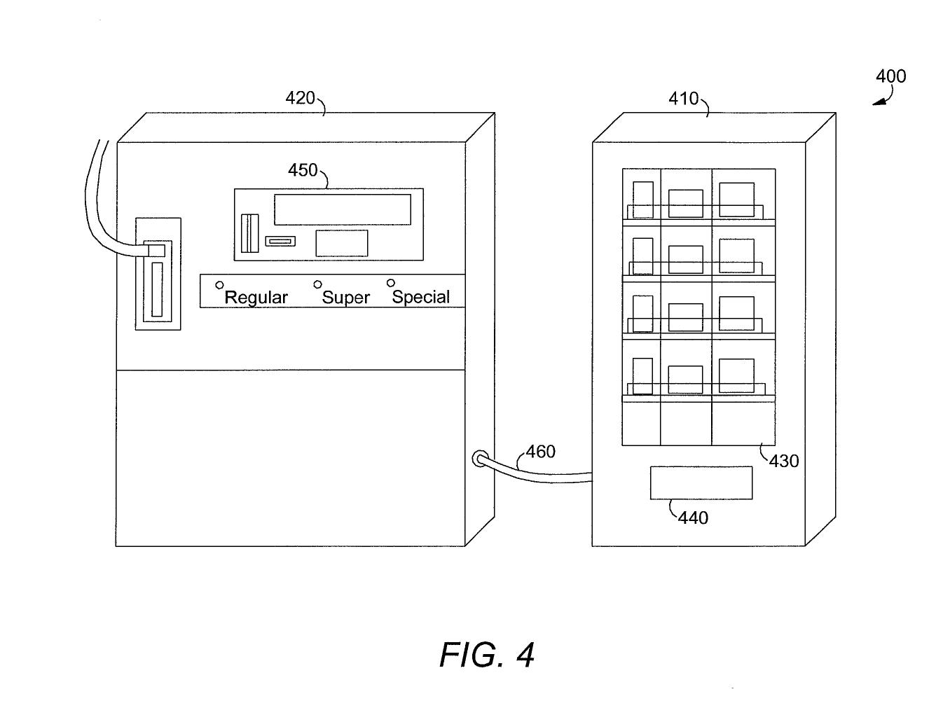

FIG. 4 illustrates a gasoline pumping station 400 including a vending machine terminal 410 and a gasoline pump terminal 420. Vending machine terminal 410 includes a presentation window 430 and a retrieval opening 440. Presentation window 430 includes a glass or Plexiglas covering which allows customers to view items contained in vending machine terminal 410. Gasoline pump terminal 420 includes a display panel 450. In an exemplary embodiment, display panel 450 includes a screen, a numeric keypad, a credit card swiping device, and a receipt printer. Alternatively, display panel 450 can integrate a screen and numeric keypad into one device, such as, a touch screen.

Vending machine terminal 410 and a gasoline pump terminal 420 are coupled together by a cable 460. Cable 460 can be any of a variety of communication cables. Preferably, cable 460 is either buried in the ground or affixed to the ground between vending machine terminal 410 and a gasoline pump terminal 420. Any mechanism facilitating communication between vending machine terminal 410 and a gasoline pump terminal 420 can be used in lieu of or in addition to cable 460, such as, wireless communication devices.

Vending machine terminal 410 can include soda, coffee, candy, snacks, and any other item which can be purchased via a vending machine. In one embodiment, vending machine terminal 410 can be located at the end of an island (a grouping of gasoline pumping terminals). In an alternative embodiment, vending machine terminal 410 can be located in the middle of the island. In another exemplary embodiment, there is an electronic door mechanism on the vending machine terminal 410 for night for security purposes. This mechanism can also be used to disable the query for vending from the display on gasoline pump terminal 420.

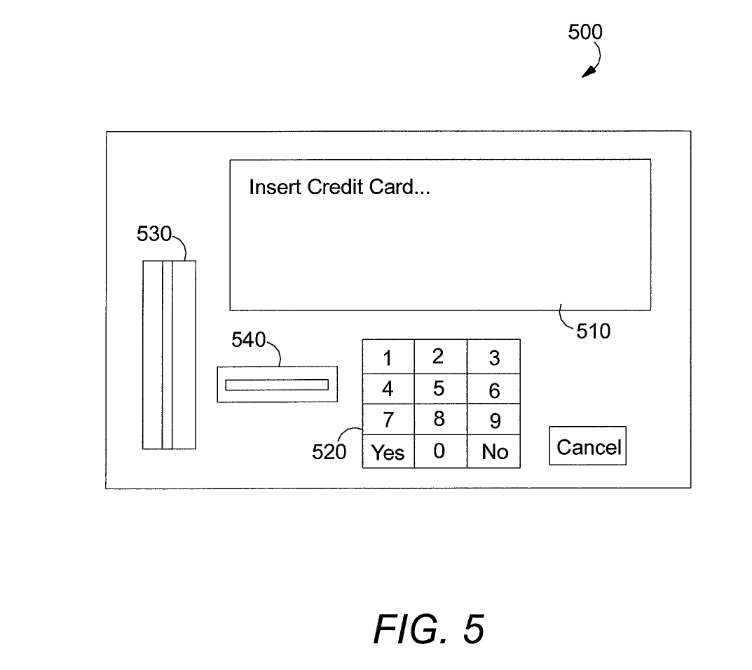

FIG. 5 illustrates a display 500 on a gasoline service station pump. Display 500 includes a screen 510, a numeric keypad 520, a card swiping device 530, and a receipt printer output 540. Screen 510 can be configured to display messages directed to the customer. In one embodiment, screen 510 displays customer instructions and queries. In an alternative embodiment, screen 510 can display advertisements, video content, television feed, or Internet information.

Numeric keypad 520 can be any of a variety of mechanisms to allow the customer to input numbers. For example, in various exemplary embodiments, numeric keypad 520 can be a touch screen device, a push button configuration, or any other input apparatus. Card swiping device 530 can be a slotted mechanism configured to read the magnetic strip on plastic credit or debit cards. Alternatively, card swiping device 530 can be any input device, such as, a magnetic detector that does not have a slotted location, such as, a SPEEDPASS detector. Receipt printer output 540 can be a slot through which paper receipts are dispensed to provide the customer a receipt of the transaction. Advantageously, fuel and non-fuel purchases can be included on the same receipt.

In an exemplary embodiment, display 500 presents a message asking the customer to insert a credit card. Once a credit card is provided, display 510 can present a selection of a type of gas and whether the customer desires to purchase an item from a nearby vending machine. The customer can select a desired item by using numeric keypad 520.

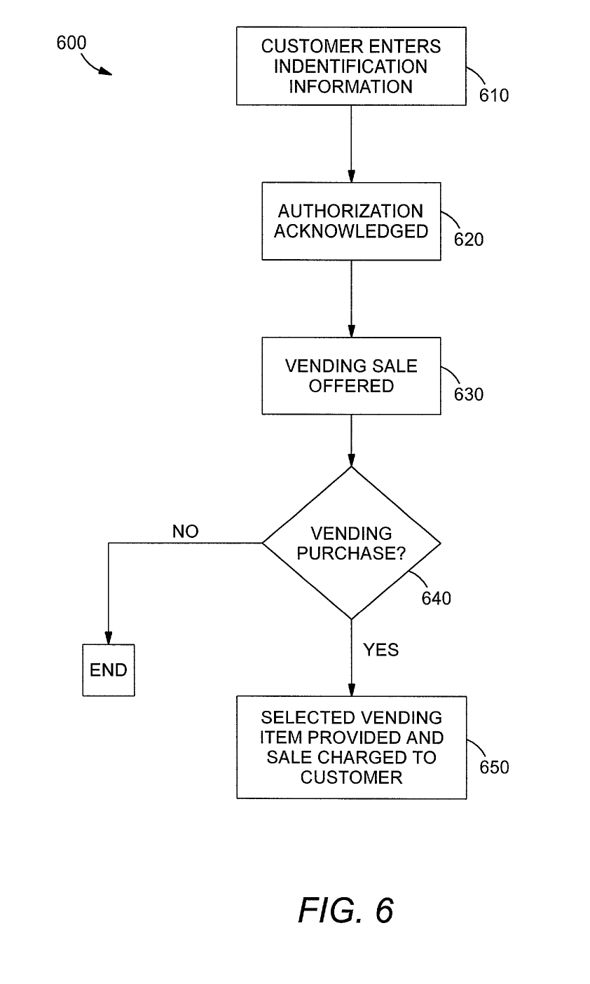

FIG. 6 illustrates a flow diagram 600 of an exemplary process for transacting non-fuel purchases using an island transaction terminal. In a step 610, a customer enters identification information at a gasoline station island terminal. In an exemplary embodiment, identification information is included in a credit card which is read by a credit card reader. Alternatively, identification of the customer can be obtained using bar codes affixed to the vehicle of the customer, magnetically readable devices which can be carried on the key chain of a customer, or any other means for identifying a customer.

After step 610, a step 620 is performed in which authorization to make a sale to the customer is acknowledged. In an exemplary embodiment, authorization is obtained from a computer server via a network. The computer server can check customer identification, such as, a credit card number for valid numbers or other identification means by checking a database either locally or remotely. A check can include a determination of whether the customer or credit card number is on a list of valid customers or numbers, or, alternatively, whether the customer or credit card number is on a list of invalid customers or numbers.

After step 620, a step 630 is performed in which a vending sale is offered to authorized customers. A vending sale can be offered after the customer has selected a grade of gasoline, during the gasoline pumping process, after the gasoline pumping process is completed, or at any other time after customer identification is provided and before the customer terminates the session. In an exemplary embodiment, a vending sale can be offered by presenting an offer on a display screen on the gasoline pump terminal. The vending sale offer can be as simple as, “Would you like to make a purchase from the vending machine?” or more complex, such as, a graphical interface where the customer can touch a pictorial representation on the display screen to identify a desired vending product.

After step 630, a step 640 is performed in which a vending purchase is identified. If there is no vending purchase selected, the process ends until new customer identification information is entered (step 610). If a vending purchase is selected, a step 650 is performed in which a selected vending item is provided and the sale is charged to the customer. In an exemplary embodiment, a vending item is selected by entering a number corresponding to the item using a keypad on the gasoline pump terminal. The sale is preferably charged to the customer on the same bill as the gasoline purchase. Advantageously, only one bill is provided for both the fuel and non-fuel sales.

Advantageously, the system and method described with reference to FIGS. 1-6 allows a customer at a gasoline service station to utilize an existing pay at the pump point of sale device to make non-fuel purchases. Non-fuel purchases have been described in this application as items available in a vending machine. However, non-fuel purchases can include purchases of goods and services not available via a vending machine. For example, non-fuel purchases can be made via the Internet where the gasoline pump terminal is configured with input and output mechanisms, such as, a touch screen which allows for Internet use.

In the exemplary embodiment where the non-fuel purchase can be provided via a vending machine, the query for a vending selection is added to the existing menu of choices at the gasoline pump terminal display. Advantageously, the non-fuel purchase selection(s) can be dispensed from the vending machine located on the gasoline island and the customer does not have to leave his or her vehicle to make the purchase. The sale of the vending item can be recorded and printed on the same charge slip or, alternatively, on a separate charge slip. Sale of a non-fuel item can be made in combination with a fuel purchase or, alternatively, the sale can be made of a non-fuel item without making a fuel purchase.

Advantageously, the system for and a method of transacting non-fuel purchases using an island transaction terminal described with reference to FIGS. 1-6 allows gasoline stations to recapture lost revenue from the sale of non-fuel items by pay-at-the-pump customers. Other advantages include overall increased sales from the convenience of at the pump non-fuel purchases, increased customer confidence in security issues, and a reduced need for employees manning a convenience store.

While the embodiments illustrated in the FIGURES and described above are presently preferred, it should be understood that these embodiments are offered by way of example only. Other embodiments may include a variety of different processes for carrying out the functions described. Further, various data structures, networks, communication systems, and computing devices may be included or substituted for those described herein. As mentioned above, non-fuel purchases possible using the system and method described can be more than the example provided of vending machine items. The invention is not limited to a particular embodiment, but extends to various modifications, combinations, and permutations that nevertheless fall within the scope and spirit of the appended claims.

What is claimed is:

1. A method of transacting non-fuel purchases using an island transaction terminal, the method comprising:
receiving customer identification information associated with a customer;
obtaining authorization to offer a sale to the customer;
offering a non-fuel purchase to the customer; and
upon receiving a request to make a non-fuel purchase, completing the sale of the requested non-fuel purchase.

2. The method of claim 1, wherein the step of receiving customer identification information associated with a customer comprises receiving credit card information using a credit card reader.

3. The method of claim 1, wherein the step of receiving customer identification information associated with a customer comprises receiving customer information from a customer identification object.

4. The method of claim 1, wherein the step of obtaining authorization to offer a sale to the customer comprises communicating with a remote computer server.

5. The method of claim 1, wherein the step of completing the sale of the requested non-fuel purchase comprises dispensing a selected item from a vending machine terminal.

6. The method of claim 1, wherein the step of completing the sale of the requested non-fuel purchase comprises communicating sale information to a web server via the Internet.

7. The method of claim 1, wherein the step of offering a non-fuel purchase to the customer comprises presenting an offer on a display screen located on a gasoline pump terminal.

8. A system for transacting non-fuel purchases using an island transaction terminal, the system comprising:
a gasoline pump terminal including a customer information input device, a display screen, and a selection device; and
a vending machine terminal coupled to the gasoline pump terminal, the vending machine terminal being configured to dispense non-fuel items upon purchase by a customer.

9. The system of claim 8, further comprising a remote computer server coupled to the gasoline pump terminal, the remote computer server being configured to provide authorization to make sales to customers based on customer identification information.

10. The system of claim 8, wherein the gasoline pump terminal and the vending machine terminal are integrated into one unitary terminal.

11. The system of claim 8, wherein the customer information input device comprises a credit card reader.

12. The system of claim 8, wherein the selection device comprises a numeric keypad.

13. The system of claim 8, wherein the selection device comprises buttons located on the vending machine terminal.

14. The system of claim 8, wherein the display screen and the selection device are integrated into one unitary device.

15. The system of claim 14, wherein the unitary device is a touch screen.

16. A system for transacting non-fuel purchases using an island transaction terminal, the system comprising:
means for receiving customer identification information associated with a customer;
means for obtaining authorization to offer a sale to the customer;
means for offering a non-fuel purchase to the customer; and
means for completing the sale of the requested non-fuel purchase upon receiving a request to make a non-fuel purchase.

17. The system of claim 16, wherein the means for receiving customer identification information associated with a customer comprises means for receiving credit card information.

18. The system of claim 16, wherein the means for completing the sale of the requested non-fuel purchase comprises means for communicating sale information to a web server via the Internet.

19. The system of claim 16, wherein the means for offering a non-fuel purchase to the customer comprises means for presenting an offer to sell a non-fuel item.

20. The system of claim 16, means for obtaining authorization to offer a sale to the customer comprises means for communicating with a remote computer server.

21. A method executed by a computing device to transact non-fuel purchases using an island transaction terminal, the method comprising:
presenting a display at a gasoline pump terminal;
presenting non-fuel purchase options at the display; and
upon receiving a selection of a non-fuel purchase, transacting the purchase of the non-fuel selection.

22. An island transaction terminal comprising:
a gasoline pump portion configured to dispense gasoline and communicate gasoline purchase information; and
a vending machine portion configured to present non-fuel items for selection and purchase, wherein the vending machine portion is coupled to the gasoline pump portion.
